(19) United States
(12) Patent Application Publication
(10) Pub. No.: US 2008/0234041 A1
(43) Pub. Date: Sep. 25, 2008

(54) Multiplication-based award augmentation for gaming

(76) Inventor: Bradley Berman, Minnetonka, MN (US)

Correspondence Address: Hollingsworth & Funk, LLC, Suite 125, 8009 34th Avenue South, Minneapolis, MN, 55425, US

(21) Appl. No.: 12/077,733

(22) Filed: Mar. 20, 2008

Related U.S. Application Data
(60) Provisional application No. 60/919,361, filed on Mar. 22, 2007.

(51) Int. Cl. G06F 17/00

(52) U.S. Cl. 463/27; 463/42

(57) ABSTRACT

Systems, apparatuses and methods for enhancing payout awards in gaming activities. A multiplication-based value is progressively increased until it is awarded. It is determined when the multiplication-based value is to be awarded to a particular gaming system in a participating group of gaming systems. The awarded multiplication-based value is applied to an amount otherwise awarded to the particular gaming system in connection with its participation in a gaming activity.

### RELATED APPLICATIONS

This application claims the benefit of Provisional Patent Application Ser. No. 60/919,361, filed on Mar. 22, 2007, to which priority is claimed pursuant to 35 U.S.C. §119(e) and which is hereby incorporated herein by reference in its entirety.

### FIELD OF THE INVENTION

This invention relates in general to games, and more particularly to systems, apparatuses and methods for enhancing payout awards in gaming activities.

### BACKGROUND OF THE INVENTION

Gaming devices such as slot machines have proved enormously popular, and in recent years have rivaled and even surpassed their table game counterparts. One reason for this popularity is the chance to win large monetary amounts, at least in the case of legalized gambling. For example, the chance of winning the largest prize on any slot machine is a common thought and motivator for many casino patrons. Slot machines and other similar gaming devices provide participants with a chance of winning the “jackpot,” even with a single, relatively small wager. Thus, unlike some games such as poker that may require significant monetary wagers for the chance to win even more significant returns, slot machines allow anybody at least the chance to win a large amount on a relatively small wager.

The jackpot of a particular machine clearly has some monetary limit, based primarily on the expected wager input and the statistical probabilities associated with that machine's payout schedule. Jackpots have been increased by grouping slot machines such that any of machine of the group can win a collective jackpot. In such cases, the participant knows precisely what that jackpot will be, as the amount is typically presented such that all of the gaming participants associated with that group can see the amount at any given time. While this aggregate jackpot is exciting to players because they do not know if and when they may win the jackpot, there is no suspense or anticipation regarding what the awarded amount would be.

It is therefore desirable to provide captivating gaming opportunities for game player to maintain player interest, where suspense and anticipation in the gaming activity enhances player interest. In furtherance of the need to attract participants to particular gaming machines, there is a continuing need to further the excitement and anticipation in the participation of gaming activities. The present invention fulfills these and other needs, and offers advantages over prior art gaming approaches.

### SUMMARY OF THE INVENTION

To overcome limitations in the prior art described above, and to overcome other limitations that will become apparent upon reading and understanding the present specification, the present invention discloses systems, apparatuses and methods for augmenting payout awards in gaming activities.

In accordance with one embodiment of the invention, a method is provided for enhancing payout awards. The method involves increasing a multiplication-based value, awarding the multiplication-based value to at least one of a plurality of gaming systems, and applying the awarded multiplication-based value to an amount otherwise awarded to the at least one gaming system in connection with participation in a gaming activity.

More particular embodiments of such a method include increasing a multiplication-based value comprises progressively increasing the multiplication-based value. Another embodiment involves awarding the multiplication-based value to a plurality of the gaming systems. One embodiment includes awarding the multiplication-based value by allocating the multiplication-based value among a plurality of the gaming systems subject to the award. Yet another embodiment involves increasing a multiplication-based value comprises increasing the multiplication-based value on average, while still another embodiment includes allowing the multiplication-based value to increase or decrease from one multiplication-based value to another multiplication-based value, while the multiplication-based value trends upwards over time.

In another particular embodiment of such a method, increasing a multiplication-based value involves increasing the multiplication-based value based on increase criteria. Thus increase criteria may include, for example, increasing the multiplication-based value as total wager amounts of the plurality of gaming systems increase. In another embodiment, awarding the multiplication-based value to at least one of a plurality of gaming systems involves determining to which of the plurality of gaming systems the multiplication-based value is to be awarded. One such example is to randomly selecting one of the plurality of gaming systems to award the multiplication-based value, and another example is to identify which of the plurality of gaming systems produced a predetermined result in connection with participation in a gaming activity. Another example is to consider player participation attributes to influence the determination of which of the plurality of gaming systems the multiplication-based value is to be awarded. Still another example includes determining when the multiplication-based value is to be awarded, an example of which is to identify a designated time, date, or date and time in which the multiplication-based value is to be awarded.

In accordance with another embodiment of the invention, a method is provided for enhancing payout awards. The method involves progressively increasing a multiplication-based value until it is awarded, determining when the multiplication-based value is to be awarded to a particular gaming system in a participating group of gaming systems; applying the awarded multiplication-based value to an amount otherwise awarded to the particular gaming system in connection with its participation in a gaming activity.

According to a more particular embodiment, such a method further includes resetting the multiplication-based value after it has been awarded. In another embodiment, determining when the multiplication-based value is to be awarded involves awarding the multiplication-based value in response to gaming activity participation on the particular gaming system. In another embodiment, this determination involves randomly selecting the particular gaming system to be awarded the multiplication-based value. An example of randomly selecting the gaming system includes for example, comparing a value randomly generated at each of the gaming systems of the group to a set value. Another example involves comparing a first value randomly generated at a server to second values randomly generated at each of the gaming systems of the group. Still another example involves comparing a first value randomly generated at a server to respective set values at each of the gaming systems of the group.

According to another particular embodiment of such a method, determining when the multiplication-based value is to be awarded involves determining which of the gaming systems of the participating group are eligible to be awarded the multiplication-based value, and monitoring award criteria for the eligible gaming systems. Some particular examples of this include, for example, where the eligible gaming systems include the gaming systems operated by an eligible user. This may involve, for example, a user that has purchased or otherwise registered for the feature; a casino VIP; a user using a card to enter and track wagers; etc. Another example of eligible gaming systems includes the gaming systems in which a wager is placed to purchase eligibility. For example, where the wager placed to purchase eligibility is unrelated to a wager of a primary gaming activity of the gaming system. In another example, the eligible gaming systems may involve the gaming systems in which a threshold wager has been placed, and/or where the gaming systems in which a threshold number of paylines has been selected for participation.

In other embodiments of such a method, progressively increasing a multiplication-based value may involve progressively increasing any one or more of a multiplier, a factorial, and/or an exponent.

In another embodiment, progressively increasing a multiplication-based value involves progressively increasing the multiplication-based value based on at least play of the gaming systems eligible for being awarded the multiplication-based value. For example, progressively increasing the multiplication-based value based on at least play of the eligible gaming systems may involve increasing the multiplication-based value as a result of wagers placed via at least the eligible gaming systems. One such example is to increase the multiplication-based value substantially proportionally to a value of the wagers placed via the eligible gaming systems. In another embodiment, the increase in the multiplication-based value is performed as a result (not necessarily an exclusive result) of wagers placed via one or more gaming system that are not eligible for being awarded the multiplication-based value.

Another embodiment further includes a plurality of the multiplication-based values, where progressively increasing the multiplication-based value thus involves progressively increasing the plurality of the multiplication-based values. Another embodiment further includes a multiplier value limitation rule(s) to reduce a rate of increase of the multiplier value upon reaching a threshold multiplier value. An alternative embodiment further includes applying a multiplier value limitation rule(s) to discontinue further increases of the multiplier value upon reaching a threshold multiplier value.

In accordance with another embodiment of the invention, a method is provided that involves progressively increasing a multiplication-based value available to a gaming system. The multiplication-based value subsists across multiple gaming system participants; i.e., the multiplication-based value continues from user to user at the gaming system. The multiplication-based value is awarded to one of the gaming system participants, and is applied to an awarded payout associated with the gaming activity being played on the gaming system.

According to more particular embodiments of such a method, awarding the multiplication-based value to one of the gaming system participants involves awarding the multiplication-based value to a current gaming system participant in response to gaming activity transpiring on the gaming system. In a more particular example, awarding the multiplication-based value to the current gaming system participant involves randomly awarding the multiplication-based value to the current gaming system participant during any gaming activity participation on the gaming system. In an alternative embodiment, awarding the multiplication-based value to the current gaming system participant involves awarding the multiplication-based value to the current gaming system participant based on a result obtained through participation in a the gaming activity.

According to other embodiments of such a method, the multiplication-based value may be any multiplication-based value, such as, for example, a multiplier value, exponent value, factorial value, etc.

In other particular embodiments of such a method, progressively increasing a multiplication-based value available to a gaming system involves increasing the multiplication-based value for a current user of the gaming system. In another embodiment, progressively increasing a multiplication-based value available to a gaming system involves increasing the multiplication-based value to a qualified user whose qualified status enables the first gaming system to activate a progressively increasing multiplication-based value feature. One example of increasing the multiplication-based value to a qualified user involves increasing the multiplication-based value to a user who has purchased a progressive multiplication-based value function. Another example is to increase the multiplication-based value to a user who has registered for a progressive multiplication-based value function. In another embodiment, progressively increasing the multiplication-based value involves increasing the multiplication-based value based at least in part on wagers placed by a plurality of users of the gaming system.

In accordance with another embodiment of the invention, a gaming apparatus is provided. The gaming apparatus includes a receiver configured to receive a progressively increased multiplication-based value associated with an enhanced payout. A processor (including a single or multi-component processor) is configured to determine a standard payout awarded in connection with a gaming activity played via the gaming apparatus, and to calculate the enhanced payout by calculating a mathematical result of applying the multiplication-based value to the standard payout. In various embodiments, the gaming apparatus may be, for example, a slot machine, computing device, mobile device, etc.

In accordance with another embodiment of the invention, a server is provided. The server includes a receiver configured to receive information influencing a multiplication-based value. A processor is configured to repeatedly calculate the multiplication-based value using the information as at least some of the calculation input, where the information is at least partially responsible for the multiplication-based value increasing at least some of the time. A transmitter is configured to provide a current state of the multiplication-based value at least at a time when the multiplication-based value has been awarded to a gaming participant.

In more particular embodiments of such a server, the transmitter is configured to transmit the current state of the multiplication-based value continuously. In other embodiments, the information is at least partially responsible for the multiplication-based value progressively increasing over time. In one embodiment, the information includes wager information. In still another embodiment, the multiplication-based value is a multiplier value capable of being multiplied by a first award received by a gaming participant to create a second award.

In accordance with another embodiment, a gaming system is provided. The system includes a plurality of gaming devices, and a server. The server includes a processor configured to repeatedly calculate a multiplication-based value using information from the plurality of gaming devices as at least some of the calculation input, where the information is at least partially responsible for increasing the multiplication-based value. Each of the plurality of gaming devices includes a receiver configured to receive the multiplication-based value from the server, and a processor. The processor is configured to determine a standard payout awarded in connection with a gaming activity, and to calculate an enhanced payout by calculating a mathematical result of applying the multiplication-based value to the standard payout.

According to more particular embodiments of such a gaming system, the server further includes a receiver configured to receive the information from each of the plurality of gaming devices via a network, and a transmitter to provide the multiplication-based value via the network. Another embodiment involves each of the plurality of gaming devices further including a transmitter configured to transmit the information to the server via a network.

In accordance with another embodiment of the invention, a computer-readable medium is provided that has instructions stored thereon which are executable by a computer system for providing enhanced payout awards. Execution of the instructions enables a multiplication-based value to be progressively increased until it is awarded. The instructions further enable functions including determining when the multiplication-based value is to be awarded to a particular gaming system in a participating group of gaming systems, and applying the awarded multiplication-based value to an amount otherwise awarded to the particular gaming system in connection with its participation in a gaming activity.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1A is a flow diagram generally illustrating a representative method in accordance with one embodiment of the invention;

FIG. 1B illustrates an embodiment of a method for enhancing payout awards according to one aspect of the invention;

FIG. 2A is a block diagram generally illustrating one embodiment of a system for enhancing payout awards in accordance with the invention;

FIG. 2B is a block diagram of a server-based system used in connection with multiple gaming systems in accordance with one embodiment of the invention;

FIG. 3 is a diagram illustrating one representative embodiment of a system according to the invention where a progressive multiplier is available to a plurality of gaming systems;

FIGS. 4A, 4B and 4C illustrate representative, exemplary embodiments of manners in which a determination is made for winning the progressive multiplier;

FIG. 5 generally illustrates a few representative criteria that may be used to determine when a new output(s) may be presented to determine if a machine/person has won the progressive multiplier;

FIG. 6 illustrates some representative alternative embodiments that may be used in connection with the present invention;

FIG. 7 illustrates a representative embodiment of a casino-style gaming device, or slot machine, in which the principles of the present invention may be implemented; and

FIG. 8 illustrates an exemplary, representative computing system capable of carrying out operations in accordance with the invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides systems, apparatuses and methods for enhancing participation in gaming activities. In accordance with one embodiment of the invention, the results or payouts of gaming activities can be increased or otherwise enhanced by manipulating a mathematical function, such as an intermachine multiplier; i.e., a multiplier that is available to multiple machines. In one embodiment, the multiplier is progressively increased, such that it increases over time.

In one embodiment, the invention provides a method for enhancing payout awards for a plurality of gaming systems, such as, for example, a group of slot machines connected via a network. The gaming systems to which the progressive multiplier is available may be referred to herein as, for example, the participating machines or participating gaming systems. The multiplier value is awarded to a particular one or more of the plurality of gaming systems in response to a triggering event, such as a random event, a result on the gaming activity on that particular gaming system(s), a random time, etc. Whatever the triggering event, the gaming system(s) is awarded the value of the multiplier at the time (or thereabouts) of that triggering event. Then, the gaming system(s) can apply that multiplier value to an awarded amount associated with the gaming activity being played.

By way of example and not of limitation, a specific use case is now described. Assume one hundred slot machines in a casino are affiliated with a progressive multiplier function in accordance with the invention. The participant of each of the affiliated machines may be notified that the machine is part of the progressive multiplier function, such as by way of any one or more of visual, audio or other signs or cues. In one embodiment, when the players participate in the gaming activities of these affiliated gaming machines, the progressive multiplier increases, although any criteria for increasing the progressive multiplier may be employed (e.g., passage of time irrespective of wager amounts). The increase may be proportional, or disproportional, to the amount of money being wagered by the participants, or the time passed, or other criteria. Assume that the multiplier value has progressively increased to a value of 10.5, and a triggering event occurs to one of the players on one of the one hundred participating slot machines. Also assume that the player had won (or on a previous play did win, or subsequent play will win) a $200 award at the time he/she was also awarded the progressive multiplier. The player would then win $200.00×10.5, or $2,100.00.

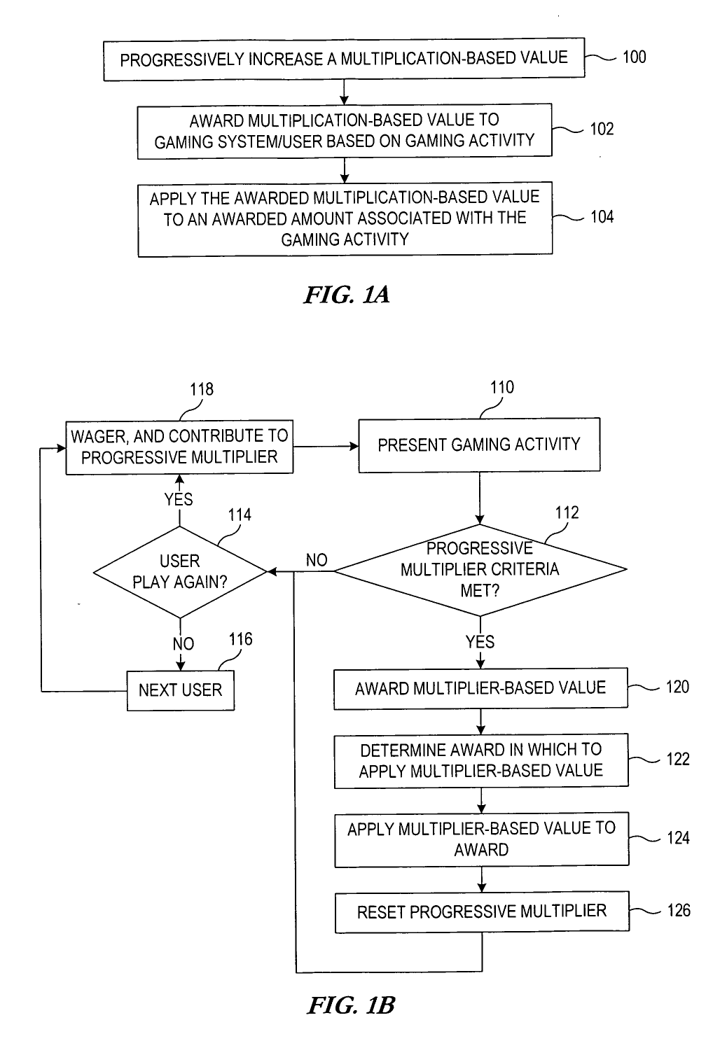

FIG. 1A is a flow diagram generally illustrating a representative method in accordance with one embodiment of the invention. In the illustrated embodiment, a multiplication-based value, such as a multiplier, is progressively increased 100, such that the value trends upwards until it is eventually awarded to a gaming system/user. In the illustrated embodiment, the multiplication-based value is ultimately awarded 102 to a gaming system/user based on gaming activity occurring in connection with that gaming system/user. In other embodiments, the gaming activity may not be a triggering event, such as in the case of a random award of the progressive multiplier where participation alone enables the player to be eligible to win the progressive multiplier. When the multiplication-based value is awarded, it is then applied 104 to an awarded amount (current, previous, subsequent amount) associated with the gaming activity. Various representative embodiments are described more thoroughly below.

Progressively increasing 100 the multiplication-based value does not require any particular formula, event, time, or other condition to cause the value to progressively increase, although embodiments of the invention do involve such formulas, events, times, conditions, etc. For example, one embodiment involves randomly increasing the multiplication-based value, which can therefore involve repeated value increases, and/or periods of times when the value is not increased at all. Such an example represents a purely random increase of the value. In some embodiments, the value may even rise one or more occasions, and then decrease, and then possibly increase again, etc., whereby the progressive increase in the value requires only that the value trends upward over time. In yet another embodiment, the “increase” in the progressive multiplication-based value need not even increase over time, but at least at some point increases. For example, one embodiment involves multiplication-based values that are randomly selected (e.g., 2.5, 3.2, 1.0, 6.5, etc.) based on passage of time, occurrence of an event(s), and/or other criteria. In such a case, the mean or average multiplication-based value may increase, stay substantially the same, and/or reduce; however increases occur at least from one random value to another, and the “increase” of the multiplication-based value in accordance with the invention is intended to include such embodiments.

In other embodiments, progressive increases in the value involve formulas ranging from loose formulas to rigid formulas. One formula is based on the wager amounts of the one or more gaming machines associated with the progressive multiplier award. As an example, the progressive multiplier may increase by 0.01 for each $1000 wagered by the one or more gaming machines involved in the progressive multiplication-based system of the present invention. In another embodiment, the progressive multiplier may increase based further on one or more other gaming machines that are not involved in the progressive multiplier, yet contribute to the award pool. In other embodiments, other factors such as date, time of day, time elapsed since a previous progressive multiplier increase, (casino) anniversary, number of gaming participants playing, wagers based on “maximum bet,” and/or any other such factors may be utilized. Thus, any formula(s), events, dates, times, conditions, etc. may be used as the criteria for increasing the multiplication-based value in accordance with the present invention.

A multiplication-based value as used herein refers to mathematical functions that are rooted in multiplication, such as a multiplier value, exponent, factorial, etc. Thus, as used herein, a progressive multiplier may also include such other multiplication-based values including exponents, factorials, etc. For example, the multiplication-based value may include a multiplier, such as 2, 3, 4.5, 6, 40329, 5¾, or any other integer or non-integer value that can be multiplied by another value. As a more particular example, if “×” represents the quantity to be multiplied, then applying a multiplier may result in functions such as 2×(referring to two times the amount “×” to be multiplied), 3×, 4.5×, 6.40329×, ½(6)×, etc. Where “×” represents a payout or other amount awarded to a gaming participant, then 2× represents doubling that payout/amount, 3× represents tripling the payout/amount, 6.40329× represents multiplying the payout/amount by 6.40329, and so forth. This multiplier embodiment represents a linear increase, as the increases are directly proportional to the increase in the multiplier value.

As another example, the progressive multiplier (i.e., progressive multiplication-based value) may be represented by an exponent value, such as ×², ×³, ×^{3.5}, etc. More particularly, if a gaming participant wins a progressive multiplier of ×³ in accordance with the invention, and the participant's payout is $50, the participant's total payout/award would be $50³, or $50×$50×$50=$125,000. A s another example, if the exponent value has increased to 3.2, the participant's total payout/award would be $50^{3.2} or $273,340.52. A s can be seen, the total increases non-linearly, and quickly, as the exponent award rises.

In yet another representative example of a progressive multiplication-based value, a factorial may be used. As is known, a factorial represents a number n that is the product of all positive integers less than or equal to n. For example, “four factorial,” often written as 3!, represents 1×2×3×4=24. Thus, a progressive multiplication-based value may be represented as a factorial, where the integer portion of the number represents a factorial, and any decimal portion remains as a decimal portion. This results in larger “steps” in the multiplier value. For example, progressive factorials may increase such as 3.56, 3.57, 3.58, 3.59, etc. The integer portion (i.e., 3) represents the factorial portion in this embodiment, where 3! equals 6, and the remaining decimal portion is then added to that factorial result. Thus, 3.56 factorial for purposes of this embodiment would equal 6.56 (i.e., 1×2×3+0.56). When the progressively increasing value reaches 3.99, the resulting multiplier value will be 6.99 (i.e., 1×2×3+0.99), and when reaching 4.00, the value equals 24.0 (i.e., 1×2×3×4+0.00). Thus, the multiplier increases from 6.99 to 24.00 when the progressively increasing value increases from 3.99 to 4.00. In this example, a payout of $100 would result in a total payout of $699.00 when the progressively increasing value is at 3.99 factorial, and would result in a total payout of $2400.00 when the progressively increasing value reaches four factorial. This may provide additional excitement, as the multiplier increases substantially when a new integer value is reached. This embodiment represents an embodiment that increases linearly between integer values, and non-linearly upon reaching each next highest integer value.

Limits may be placed on multipliers, exponents, factorials, etc. to limit the casino's exposure and thus limit the enhanced award. For example, limitation rules may be applied such that progressive multipliers involving an exponent may increase from 1.0 to 2.0. In such an example, when reaching 2.0, the exponent may be reset to 1.0 (or other value), remain at 2.0, increase at a slower rate, apply to smaller payouts, etc. In other embodiments, there are different limitations, or no limitations.

According to one embodiment of the invention, the progressive multiplier(s) (i.e., at least one progressive multiplier-based value) may be associated with a single gaming system. For example, in the case of a gaming kiosk or “slot machine,” the progressive multiplier may be associated with that particular kiosk/machine. In this embodiment, the multiplication-based value increases on that particular kiosk/machine until it is won by a player or otherwise reset or discontinued. Therefore, such an embodiment involves an “inter-user” embodiment, where the progressive multiplier continues to build on the machine regardless of who is participating on that machine.

In another embodiment, the progressive multiplier may increase for a particular user. For example, a casino patron may be assigned a card that includes one or more of electronic credits, identification information, etc. In one embodiment, the progressive multiplier is unique to that user, or a designated group of users, such that the multiplier value increases for that user(s). Thus, the user may be eligible by way of the card, or by way of registering for eligibility for the progressive multiplier function, or by way of any other eligibility requirements. One particular example is that a user purchases a progressive multiplier function, and on participating systems (which may be all or some subset of the gaming machines in an area, casino, region etc.) the participant has his/her own progressive multiplier that increases. The increase in the multiplier value may be based on any desired criteria, such as total monies wagered, use of a particular type/brand of gaming system, per trip to the casino, etc. In this manner, a win of the progressive multiplier would be won by the particular card holding participant, if that participant met the criteria for winning the progressive multiplier.

One embodiment involves the use of a progressive multiplication-based value that is accessible to a plurality of gaming systems. For example, an area of a casino may have multiple slot machines grouped such that any of these slot machines associated with the group is capable of winning the progressive multiplier. Such a “group” may be defined in any desired fashion. For example, the “group” may be limited to a single gaming system, a group of gaming systems forming a subset of the gaming systems in a casino, all gaming systems in a casino, some/all gaming systems in geographic regions including multiple casinos, etc. In this manner, each of the individuals participating in a gaming system that is part of the “group” is eligible to win the progressive multiplier. All or some subset of the gaming systems of the group may also contribute to the manner in which the progressive multiplier is increased. For example, in one embodiment, the rate at which the progressive multiplication-based value increases is dependent on the total amount wagered by the gaming systems of the “group” of gaming systems associated with the progressive multiplier function. Thus, in such an embodiment, the progressive multiplier is associated with a plurality of gaming systems. For example, one embodiment of the invention involves a progressive multiplier that can be awarded to any of a plurality of slot machines associated with that progressive multiplier. In such a case, if any of the slot machines associated with that progressive multiplier meet the condition(s) for being awarded the progressive multiplier, then that condition(s)-meeting slot machine will be awarded the progressive multiplier to be applied against a past, current and/or future payout associated with the gaming activity otherwise being participated in.

More particularly, one embodiment of applying a winning progressive multiplier to a “past” payout is to apply the multiplier by the most recent winning amount. For example, if the participant recently won a $10 award by, for example, receiving a certain number of like symbols in a row on a payline, then if the participant wins the progressive multiplier before winning any other payouts the progressive multiplier is applied to the $10 award. Using a past payout may involve any past payout(s), such as the most recent single winning payout, the most recent multiple winning payouts (e.g., the sum of the last three payouts), the highest payout in a given time (e.g., the highest payout in the last 10 reel spins), the lowest payout in a given time, and/or any other desired criteria.

In another embodiment, the progressive payout may be applied only when the awarded gaming system has actually won an amount on that particular play. This is an example of being awarded the progressive multiplier to be applied against the current payout associated with the gaming activity. For example, if the gaming machine is awarded the progressive multiplier for a particular play of a gaming activity (e.g., a spin of the reels in a slot machine), but the gaming activity does not result in any winning symbol combination that provides a payout, then the participant would win $0.00 times the multiplier, thereby resulting in an award of $0.00. In another embodiment, the symbol combination (or other event) that results in winning the progressive multiplier has an award also associated with it, so that the participant will always win some amount if the progressive multiplier is won. For example, three star symbols in a row may be a triggering event to cause the participant to win the progressive multiplier, and three start symbols in a row may also have an associated payout of $100. Thus, if the multiplier had reached a value of, for example, 15.5, the resulting payout would be $1,550.00.

In another embodiment, future payouts may be applied to a winning progressive multiplier. For example, assume a gaming participant wins the progressive multiplier. This may be applied to the next one (or more) spins that actually win a payout amount. For example, if the participant wins a progressive multiplier of 6.76, the participant continues with the gaming activity until the next winning spin which is assumed to provide a payout of $10.00, for a total of $10×6.76 or $67.60. In one embodiment, a future gaming activity result may be used with the awarded progressive multiplier only where a current gaming activity did not result in an award. Any future payout(s) may be used exclusively, or in combination with one or both of past and current payouts to arrive at the result.

FIG. 1B illustrates one particular embodiment of a method for enhancing payout awards according to one aspect of the invention. In the illustrated embodiment, a gaming activity is presented 110. The gaming activity may be any game playable via the gaming system. For example, the gaming activity may be any electronic gambling event that can be played on a gaming system such as a slot machine. As a particular example, a gaming activity may involve a slot game played on a slot machine, where some number of correlating symbols provides a winning result on a payline. To be awarded the progressive multiplier, some criteria must be met, whether the criteria involves an entirely random award of the progressive multiplier to an eligible gaming system, or involves other criteria such as a particular symbol combination, time, date, etc. Whatever the criteria is, if this criteria is not met as determined at decision block 112, the user may opt to play again as determined at decision block 114. If the user does not want to play again, another user 116 may play the particular gaming machine. In the illustrated embodiment, either the current user or the next user(s) will be eligible to win the progressive multiplier, where each user essentially contributes to the increase or “progression” of the multiplier value. For example, by way of user wagering, the user(s) contribute 118 to the progressive multiplier, and further gaming activities may be presented 110.

When the criteria for winning the progressive multiplier has been met as determined at decision block 112, the multiplier is awarded 120. For example, a particular symbol combination, such as three star symbols presented on any active payline(s), may need to be achieved to be awarded the progressive multiplier. Because (in the illustrated embodiment) the multiplier value increases with continued participation at least until it is awarded, the multiplier value is not a constant value. The multiplier value awarded is the value that the multiplier value reached at the time that the criteria was met 112. For example, the multiplier might be 9.847 at the time that the criteria was met 112, and it is this multiplier value that is to be applied 124 to an award resulting from the gaming activity.

As previously indicated, the award resulting from the gaming activity may be a result of any one or more of past, current and/or future awards relative to when the progressive multiplier is awarded. Thus, the particular award to which the progressive multiplier is to be awarded is determined 122. For example, in an embodiment where the most recent award (including a past award or a current award) is the relevant amount, then that amount is determined 122 so that the awarded progressive multiplier value can be applied 124 to it.

At some time, embodiments of the invention involve resetting 126 the progressive multiplier value after it has been awarded. The value to which the multiplier is reset is a matter of choice. For example, in the case where the multiplication-based value is a multiplier, the multiplier may be reset to “1.00” after it has been awarded, where it will increment from 1.00 from that point forward. Any other multiplier value may be the reset value, such as 2.00, 3.20, etc. The same holds true for other multiplication-based values, such as exponents, factorials, etc. For example, an exponent value may be reset to a value of “1,” such that an award of $50 when the exponent value is reset to “1” results in $50¹ which equals $50. A s another example, the exponent value may be reset to “1.1,” such that winning the progressive multiplier-based value of 1.1 just after reset results in some increase in the original gaming activity award—e.g., a gaming activity award of $50 results in a total award of $50^{1.1} or $73.94. A ny desired reset value may be used.

In one embodiment, the multiplier, exponent, factorial or other multiplication-based value is awarded as an integer value, and any fractional or decimal portion is disregarded or included with a subsequent multiplication-based value. For example, assume that only integer values are used for a progressive multiplier in accordance with the invention, such that a multiplier of 3.41 awards the integer multiplier of “3.” In such a case, the 0.41 remaining portion may be disregarded. In another embodiment, the fractional/decimal portion may be used to round up or down to the nearest integer value (e.g., 3.41=3.00).

In another embodiment, the fractional/decimal portion is added to a subsequent reset value. For example, assume the reset value for a multiplier is two times (e.g., 2×), and the participant wins a multiplier of 6.85 in connection with a gaming activity award of $50.00. In such a case, the integer portion of the multiplier award is “6” (i.e., integer portion of 6.85), and the remainder is 0.85. This fractional/decimal portion may then be added to the reset value of 2×, such that the reset value is now 2.85. If the awarded multiplier was 11.03, the applied multiplier would be “11 ,” and the new reset value from which the progressive multiplier starts would be N.03, where “N” represents the integer reset value.

In another embodiment, multiple multiplication-based values may be used, and/or multiple reset values. For example, participation attributes such as the wager amount, number of paylines played and/or other attributes may be used to determine the particular multiplier and/or reset value to use. One specific example can be illustrated in the context of a three-payline slot machine, where the participant has the option of playing one, two or three of the available paylines. If the participant plays one payline, the multiplier may be dependent upon this choice such as having a first rate of increase of the progressive multiplier amount and/or a first maximum amount for the multiplier amount maximum. For example, the first rate of increase may be Increase Rate1 (IR1), and the maximum that the multiplier may reach could be, for example, 2×. If the participant plays two paylines, the multiplier may be dependent upon this choice such as having a second rate of increase (IR2) of the progressive multiplier amount and/or a second maximum amount for the multiplier amount. For example, the rate of increase may be greater than the first rate of increase (e.g., IR2>IR1), and the maximum multiplier value may be, for example, 10×. If the participant plays all three paylines, the multiplier may be dependent upon this choice such as having a third rate of increase (IR3) of the progressive multiplier amount and/or a third maximum amount for the multiplier amount. For example, the rate of increase may be greater than the first and second rates of increase (e.g., IR3>IR2>IR1), and the maximum multiplier value may be, for example, 100×. Another representative example involving a fifteen-payline embodiment, provided for purposes of illustration and not of limitation, is shown in Table 1 below:

TABLE 1

| | INCREASE RATE | MAXIMUM |
|---|---|---|
| PAYLINES | (relative to single payline) | MULTIPLIER VALUE |
| 1 | 1.0 | 2× |
| 2-4 | 1.2 | 5× |
| 5-10 | 1.3 | 10× |
| 11-14 | 1.5 | 20× |
| 15 | 2.0 | 100× |

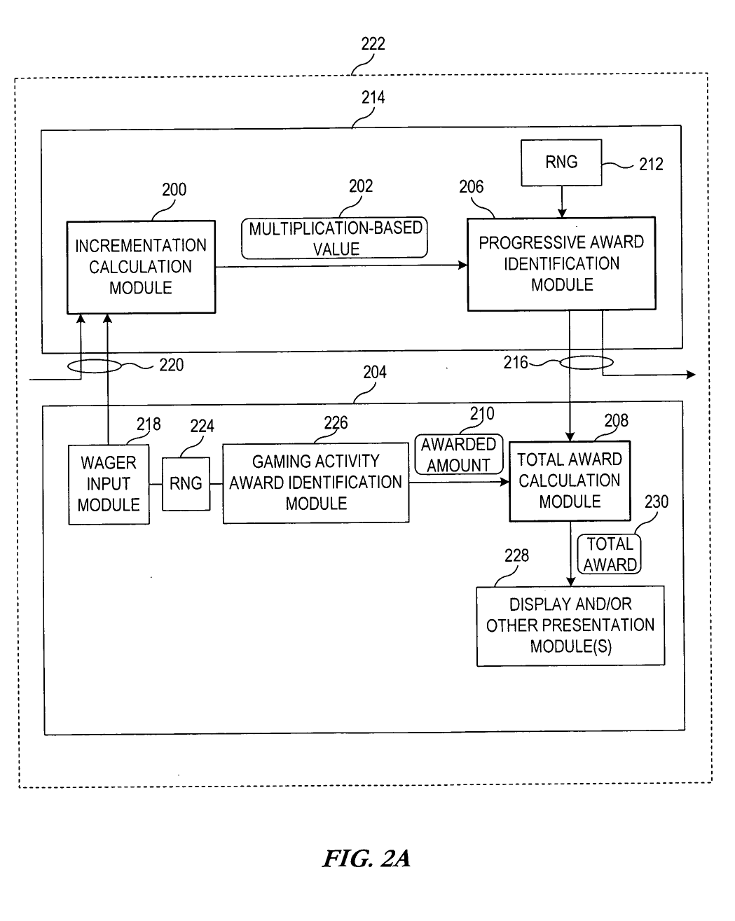

FIG. 2A is a block diagram generally illustrating one embodiment of a system for enhancing payout awards in accordance with the invention. In the illustrated embodiment, the system includes at least a module 200 configured to progressively increase a multiplication-based value 202 available to a gaming system 204, and a module 206 to determine if the gaming system 204 has been awarded with the multiplication-based value 202. The illustrated system of FIG. 2A also includes at least a module 208 to calculate or otherwise apply the awarded multiplication-based value 202 to an awarded payout 210 associated with a gaming activity to which the participant is engaged.

In other embodiments, the progressive award identification module 206 may receive random information used to determine if the participant of the gaming system 204 is to be awarded the multiplication-based value 202. For example, a random number generator (RNG) 212 may provide substantially random information that can be compared against a value(s) associated with the gaming system 204, whereby a match of the RNG 212 information and the value(s) associated with the gaming system 204 indicates that the gaming system 204 has won the value 202.

In one embodiment, modules such as the incrementation calculation module 200, progressive award identification module 206 and RNG 212 may be provided by a system 214 external to the gaming system 204, such as a server or other computing system capable of communicating information to the gaming system 204. In such an embodiment, the system 214 provides a progressive multiplier award notification to any of the multiple gaming systems coupled to the system 214, as depicted by the multiple award notification paths 216.

In one embodiment, the plurality of gaming systems includes gaming system 204 and others coupled to the system 214 and eligible to be awarded the progressive multiplication-based value 202. In this embodiment, each gaming system 204 can provide information regarding a wager amount, number of paylines, and/or other information from a wager input module 218 to the incrementation calculation module 200. Thus, in such an embodiment, the amount of incrementation of the value 202 is dependent, at least in part, on the amount wagered (and/or other designated information) by the participant of the gaming system 204. Where the system 214 operates with multiple gaming systems, the incrementation calculation module 200 may receive such information from multiple systems, as depicted by the multiple wager information paths 220.

In another embodiment, the gaming system 204 and system 214 may be integrated into a single gaming system, as depicted by dashed box 222 representing an integrated system 204/214. This embodiment may be used where a single machine has its own progressive multiplier—e.g., where a progressive multiplier is limited to participation on a single gaming system 222.

Whether a single system 222 or discrete systems 204/214, one embodiment involves a gaming system 204 that includes a wager input module 218, RNG 224, gaming activity award identification module 226, award calculation module 208 and a display or other presentation module 228. The wager input module 218 determines an amount wagered by a participant for a particular gaming activity, and may provide information to the incrementation calculation module 200 to enable the progressive multiplication-based value 202 to be increased. It should be noted that an “increase” in the progressive multiplier may be a small enough incrementation that a rounded value of the multiplication-based value 202 is not actually affected. For example, an increase in the multiplier value may increase from 4.9834 to 4.9835. If the awarded multiplier is rounded to the hundredths place, then this increase would not change the awarded multiplier of 4.98.

The gaming system 204 may also include an RNG 224. In an embodiment where the systems 204 and 214 are provided in a single system 222, the RNG 224 and RNG 212 may be the same RNG. The RNG 224 provides the random information needed for the gaming activity award identification module 224 to determine any gaming activity awards. For example, the progressive multiplier function of the present invention may be a secondary award feature of the gaming system 204, where the gaming system 204 has one or more standard gaming activities associated therewith. As a more particular example, the gaming system 204 may host a fifteen-reel slot game as a standard gaming activity, where the RNG 224 is used to provide the random information required to determine if the participant is a winner of that standard game's activity. Any resulting awarded amount 210 may be increased by an awarded multiplication-based value 202. For example, the award calculation module 208 applies any awarded multiplication-based value 202 (e.g., 3.25×) to any awarded amount 210 (e.g., $50) to reach a total amount (e.g., $162.50).

The multiplication-based value 202, awarded amount 210 and/or total amount 230 may be displayed on a display 228 or other presentation module. Other presentation modules may include any module use to present information, such as audio, audio-visual, tactile, etc. It should also be recognized that the various modules depicted in FIG. 2A may be discrete modules, or some/all of these modules may be integrated into one or more modules. For example, in one embodiment, a processor(s) executing instructions may be implemented such that different programs of instructions executed on the processor(s) may represent the modules. Other embodiments may involve one or more of the modules being implemented using hardware or otherwise separate from any processor-based embodiment.

FIG. 2B is a block diagram of a server-based system used in connection with multiple gaming systems in accordance with one embodiment of the invention. In the illustrated embodiment, the server 214 corresponds to the award system 214 of FIG. 2A. Components of FIG. 2B corresponding to those of FIG. 2A are depicted with like reference numbers. Accordingly, for purposes of the description of the embodiment of FIG. 2B, the server 214 of FIG. 2B generally corresponds to the system 214 of FIG. 2A and includes the incrementation calculation module 200, multiplier value 202, award identification module 206 and RNG 212.

The embodiment of FIG. 2B involves the server 214 providing progressive multiplier functionality in accordance with the invention to a network or group 250 of gaming modules 204, 204B, . . . 204n. The group 250 may represent a group of slot machines or other gaming machines within a physical proximity of each other, such as an area on a casino floor. The group 250 may also include a networked group of gaming modules, which may include casino machines and/or computing systems (e.g., desktop computers, workstations, personal digital assistants, mobile/handheld devices, etc.) capable of communicating data over a network such as the Internet.

In one embodiment, information relating to a device's activity and/or wagers is provided to the server 214, as depicted by paths 220 in both FIGS. 2A and 2B. Thus, this embodiment involves increasing the progressive multiplier based at least in part on the activity and/or wagers placed by participants of the gaming modules 204, 204B, 204n. In other embodiments, this information may not need be provided to the server 214, such as in an embodiment that increases the multiplier value 202 based on, for example, the passage of time, random times/events, or other attribute unrelated to the activity/wager occurring within the group 250.

The award identification module 206 is coupled, or capable of coupling, in a desired manner to each of the gaming modules 204, 204B, 204n. Thus, a winning gaming module can be notified of being awarded the progressive multiplier value 202 when it is determined at the award identification module 206 that a particular one (or possibly more) of the gaming modules 204, 204B, 204n has been awarded the progressive multiplier. In this regard, gaming module 204 is shown as having won a payout of $100 by way of its standard gaming activity, and has won the progressive multiplier value 202 of 36.783×, for a total payout of $3,678.30.

The multiplier value 202 may be presented to the participants operating the gaming modules 204, 204B, 204n. For example, a gaming module may have an updatable display area 252 that shows the progressive multiplier value 202 as it increases. In another representative embodiment, the progressive multiplier value 202 may be displayed on a common presentation panel 254 substantially visible in the area of the group 250 of gaming modules. For example, the electronic panel 254 may show the progression of the upwards trend of the communal multiplier value. In this manner, casino patrons can see the progressive multiplier value, and may be enticed to participate in the gaming modules associated with the group 250.

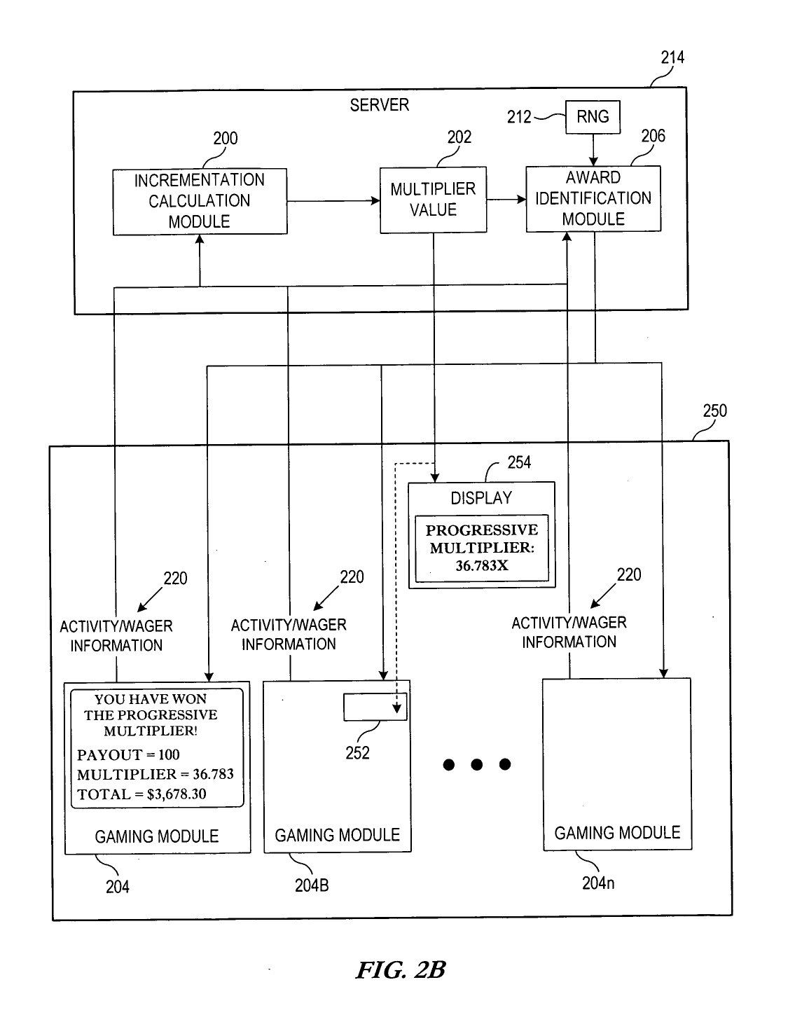

As indicated above, the present invention may be used in a number of different arrangements. For example, a progressive multiplier may be user-based, such as where a user has an electronic card capable of tracking a user-unique progressive multiplier in accordance with the present invention. A progressive multiplier may be machine-based, such as where the progressive multiplier is associated with a particular casino gaming system, slot machine, kiosk, local software application, etc. In such a case, the multiplication-based value trends upward on that device, whereby any user of that device is eligible to win the progressive multiplier of the invention. In one embodiment, the progressive multiplier is used with a plurality of different gaming systems, where each of the associated gaming systems is eligible to be awarded with the progressive multiplication-based value. FIG. 3 is a diagram illustrating one representative embodiment of a system according to the invention where a progressive multiplier is available to a plurality of gaming systems.

FIG. 3 generally illustrates that the present invention may be used at a single location, or at multiple locations. Thus, the progressive multiplication-based function of the invention may be used in stand-alone or distributed systems. The embodiment of FIG. 3 includes three locations, shown as location-A 300, location-B 302 and location-C 304. Other devices are also shown at other “locations,” such as the mobile phone 306, personal digital assistant 308 or other handheld unit, computers, and/or other device capable of engaging in remote gaming. The progressive multiplier may be used at a single location, such as location-A 300. In such case, some or all of a group 310 of gaming systems may be coupled to a server 312 or other computing system that manages the progressive multiplier of the present invention. In the illustrated embodiment, a display panel 314 shows what the current progressive multiplier value is.

The progressive multiplier may be available to gaming systems as different locations. For example, some or all of the gaming systems may be coupled by way of a network(s) 316, which may include wired and/or wireless networks. Examples of a wired network include a local area network (LAN), wide area network, global area network (GAN) such as the Internet, proximity networks such as ad-hoc peer-to-peer networks and Bluetooth networks, etc. The element 318 represents a wireless access point for infrastructure-based networks such as a cellular data network, or for infrastructure-less networks such as a wireless access point in a local area network (e.g., 802.11a/b/g, Bluetooth, etc.).

Gaming systems 320 at another location, e.g., location-B 302, may be associated with the same progressive multiplier gaming activity as location-A 300, or may be associated with it's own progressive multiplier gaming activity. In the illustrated embodiment, the gaming systems 320 are associated with the same progressive multiplier gaming activity as is available to the gaming systems 310 at location-A 300 and the gaming systems at location-C 304. The server 312 may be coupled to a server(s) 322 at location-B 302, and a display panel 324 may also be used to present the current progressive multiplier to the gaming systems 320 at location-B 302. The progressive multiplier may be presented to gaming systems in other manners as well, such as via a display 326 on the gaming system itself as depicted on the gaming systems at location-C.

Any manner of determining whether a machine/player has won the progressive multiplier may be used in accordance with the present invention. For example, each participating machine (e.g., computer, slot machine, gaming kiosk, etc.) may generate a random number on each play (e.g., each “spin”), each time duration (e.g., each minute), each wager threshold (e.g., after each $5 played), and/or any other desired criteria. In another embodiment, a server may alternatively (or additionally) associate a random number with each machine based on the same or different play criteria. These random numbers associated with the participating machines may be compared to a target random number generated at, for example, the server or other central location. If any of the random numbers associated with the participating machines matches the generated target random number, that machine(s) wins the progressive multiplier. If multiple machines win, the multiplier can be awarded in whole to each of the winning machines (e.g., progressive multiplier is 10.2, so each winning machine is awarded a multiplier of 10.2), or may be allocated between the winning machines (e.g., progressive multiplier is 10.2, so each of two winning machines is awarded a multiplier of 5.1).

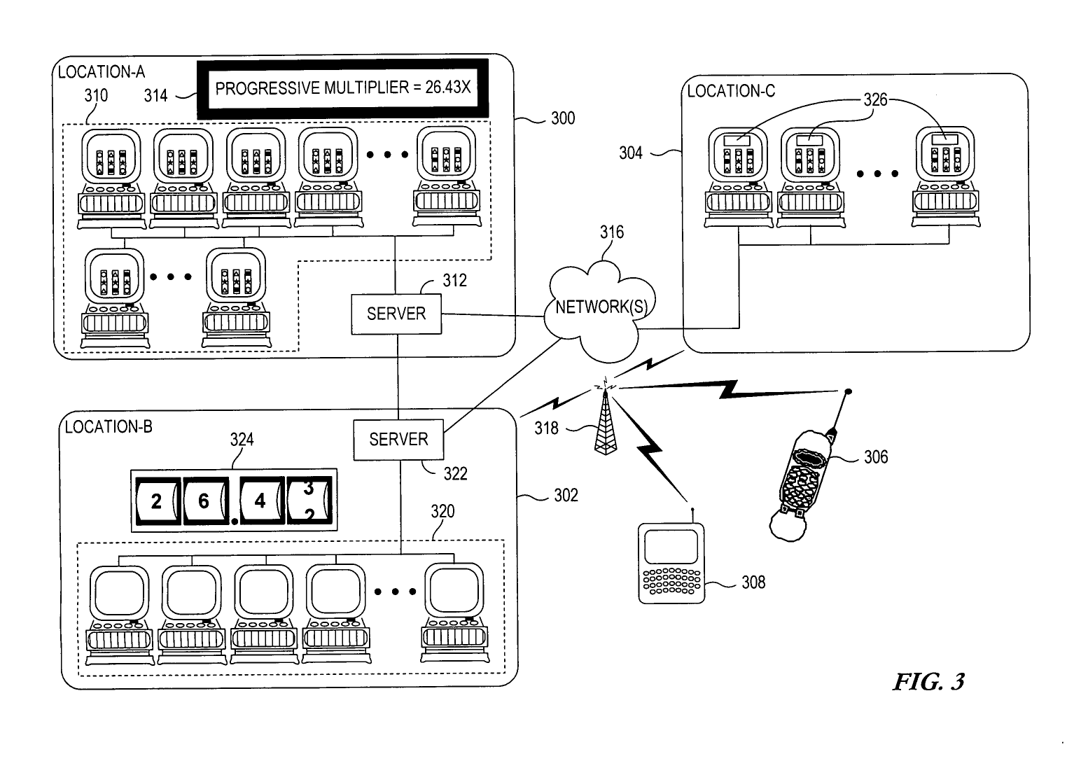

FIGS. 4A, 4B and 4C illustrate representative, exemplary embodiments of manners in which a determination is made for winning the progressive multiplier. Like reference numbers are used for the items in FIGS. 4A, 4B and 4C where appropriate. In the embodiment of FIG. 4A, a gaming system 400 may store or otherwise be privy to a winning number(s) 402. For example, the gaming system 400 may include memory or other storage component (not shown) to store a winning number(s) (including numeric or other winning indicator) 402. The winning number may remain the same, or may be changed when desired. The gaming system 400 randomly generates values using, for example, the random number generator (RNG) 404. A comparator 406 is employed, which may be implemented in hardware or software. For example, a processing module (not shown) may execute software to compare the value of the winning number 402 and the current output of the RNG 404. If a match occurs, the gaming system 400 is awarded the progressive multiplier.

In another embodiment shown in FIG. 4B, a plurality of gaming machines 400A, 400B . . . 400n are shown, each of which may be equipped with an RNG. A winning number 402 may be fixed at a central system, such as a server 410. The numbers generated by each of the RNGs of the gaming systems 400A, 400B, 400n are compared to the winning number 402 at the server 410 using a comparator 406. Thus, the winning number(s) 402 may be fixed, such as 36589, and each of the participating machines 400A , 400B, 400n generates random numbers. If any of the generated numbers matches the fixed winning number 402 (e.g., 36589), that machine wins the progressive multiplier.

In still another representative embodiment shown in FIG. 4C, each participating machine 400A , 400B, 400n may be assigned a particular winning number 402A , 402B, 402n. A random number is generated by the RNG 404 at a central location (e.g., server 410). The number generated by the RNG 404 is then compared 406 to the winning numbers 402A , 402B, 402n associated with each of the gaming machines 400A , 400B, 400n to determine if any of the machines is awarded the progressive multiplier. The random number may be generated continuously, or periodically, or at particular times, or in connection with particular events, etc. A match between the generated random number results in that machine(s) being awarded the progressive multiplier.

Any embodiment implementing a group or collaboration of systems (e.g., server/client arrangement) may include further gaming systems and/or servers, as also depicted in FIG. 4C. For example, additional gaming systems 400(n+1) may be provided at a different location, yet may participate in the progressive multiplier via a network 420. The network may be any type of network including but not limited to infrastructure-based networks (e.g., cellular data networks such as GSM/GPRS, PCS, etc.), proximity networks (e.g., Bluetooth, wireless local area networks, etc.), data networks (local area networks, the Internet), etc.

The assigned machine numbers and generated random number may be small or large as desired, and the size of the number may affect the probability of a match. The frequency in which the random numbers are generated/compared also affects the probability of a match. In one embodiment, only those participants wagering a minimum threshold amount will be considered for winning the progressive multiplier.

Triggering event(s) that can also or alternatively give rise to awarding the multiplier. For example, a participating machine(s) can get a “mystery” award which just randomly awards the progressive multiplier to one or more of the participating machines. In another representative embodiment, a progressive multiplier may be awarded to a machine(s) that has been randomly selected and has won a minimum amount such as $100.

In another representative embodiment, a progressive multiplier may be awarded based on a symbol combination occurring on the player's machine. For example, it may be based on a combination of symbols arising during the player's primary gaming activity, or where a subsymbol or other indicator matches a predetermined symbol combination. An additional criteria may be that a minimum wager and/or number of paylines must be played to be eligible for the progressive multiplier. Alternatively, the progressive multiplier may be awarded in connection with non-primary gaming activities, such as in connection with a bonus or other auxiliary gaming event.

The awarded multiplier can be applied to any result(s). For example, it may be applied to a current winning result. In one embodiment, if the player has not won an amount on the current play, the awarded progressive multiplier is essentially lost (e.g., a multiplier of 100 times a result of $0 is a total of $0). In another embodiment, if the player has not won an amount on the current play, the awarded progressive multiplier is applied to past or future results, whether a win occurs or not. For example, the awarded multiplier may be applied to a past winning result(s) (e.g., the last one, two, or other number of winning results), one or more future winning result(s) (e.g., the next winning result, the next result winning at least some minimum amount, the sum of the next ×winning results), etc.

In one embodiment, there may be multiple “levels” of the progressive multiplier. For example, three multiplier levels may be provided, such as 2×, 100× and 1000× multiplier levels. Such levels may indicate, for example, the starting point of a multiplier, or the maximum of the multiplier. Each multiplier may progressively increase. Certain criteria can be used to determine which level a particular player and/or machine is eligible for. For example, where one credit is played, the player may be eligible for the 2×multiplier level; where two credits are played, the player may be eligible for the 100×multiplier level; and where the maximum credits are played, the player may be eligible for the maximum multiplier level. Other criteria may additionally or alternatively be used, such as whether the player has a casino card, which symbol combination occurred, number of paylines, etc.

As previously indicated, the awarded multiplier value may be the exact value, or a rounded value. For example, if the progressive multiplier value is 10.254 when awarded, the multiplier value awarded may be 10.254, or may be rounded to a whole number (e.g., 10), or rounded to a particular decimal point (e.g., 10.3). In another embodiment, any residual over a rounded amount may be kept by the casino. In another embodiment, any residual over a rounded amount may be added to the otherwise reset value. For example, if the award is 10.56, a 10× multiplier is awarded, the progressive multiplier is reset to 2×, and the residual 0.56 is added to the reset value such that the new starting multiplier value is 2.56×.

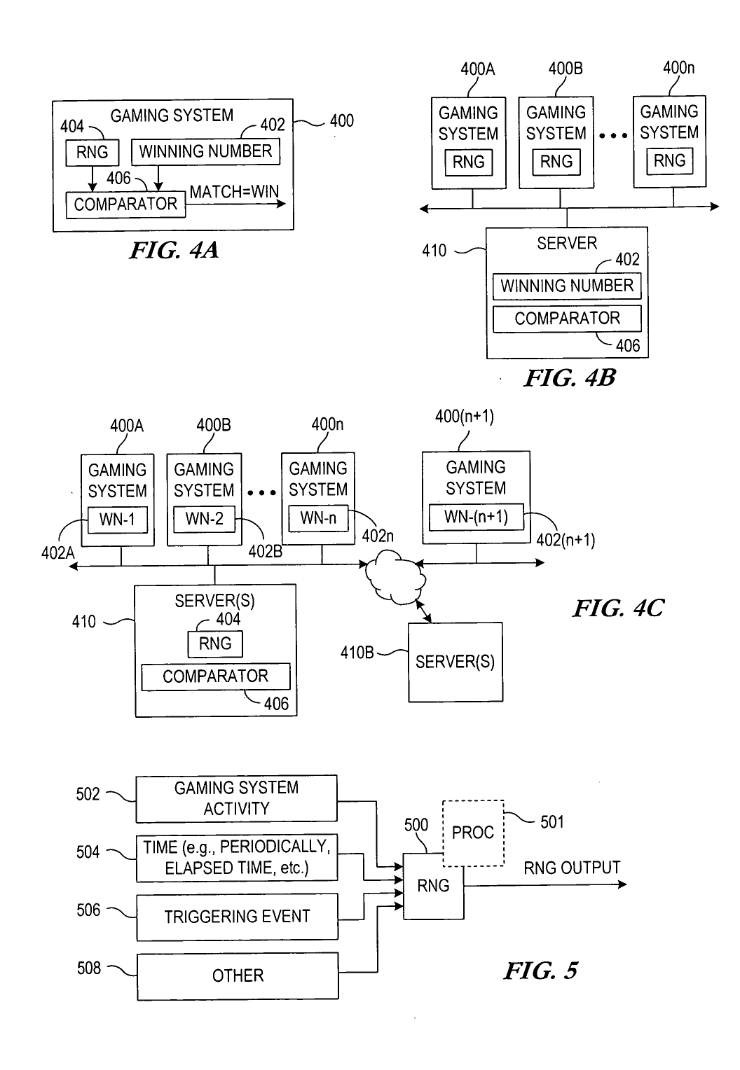

As indicated above, the gaming systems and/or gaming participants may be eligible to win the progressive multiplier based on certain factors. FIG. 5 generally illustrates a few representative criteria that may be used to determine when a new output(s) may be presented to determine if a machine/person has won the progressive multiplier. For example, an RNG 500 may provide an output if any one or more criteria occurs, such as certain gaming activity 502, time-related events 504, triggering events 506 or other criteria 508. Gaming system activity 502 may include any one or more occurrences of a current gaming activity such as, for example, wager amounts, paylines played, an obtained symbol(s) or symbol combination, etc. Time-related events 504 may include, for example, specific times (every minute, on the minute), time durations, periodic or pattern events, etc. Triggering events 506 may include other events, such as random awards and any other 508 desired event. In other embodiments, the RNG 500 is not dependent on any criteria, and may continually provide random outputs to be compared for purposes of identifying a winning machine/player. The RNG 500 may be a stand-alone device, or may be implemented in a processor 501 or other processing system.

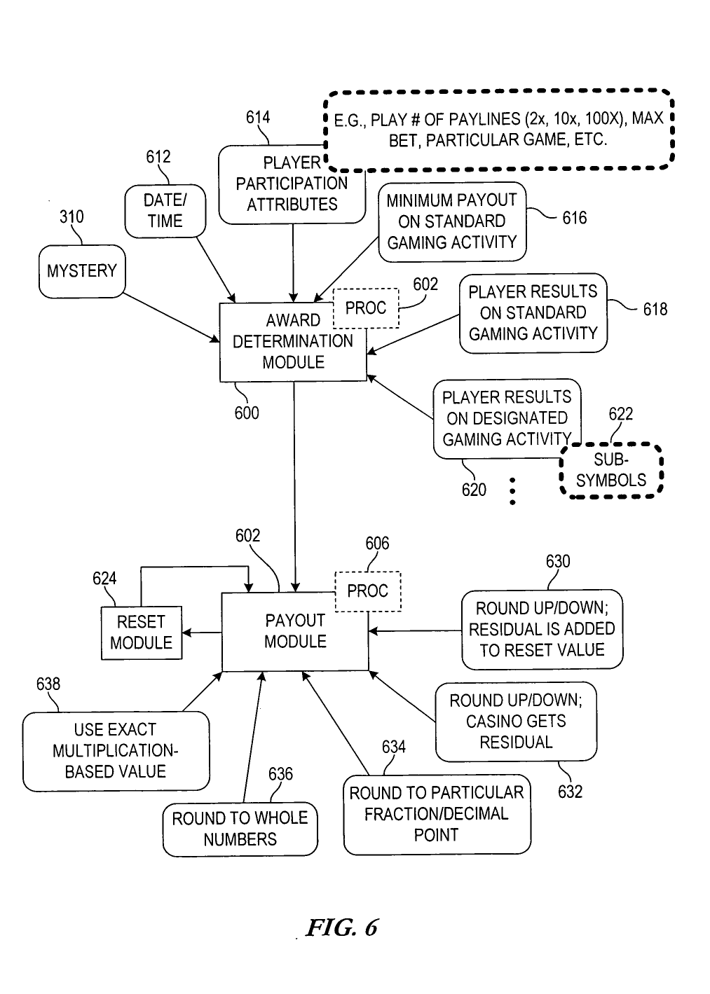

As indicated above, the progressive multiplier function of the present invention is capable of operation in a wide variety of embodiments. FIG. 6 illustrates some representative alternative embodiments that may be used in connection with the present invention. The illustrated and described embodiments of FIG. 6 are for purposes of illustration, and clearly do not represent an exhaustive list of embodiments. Rather, the illustrated/described embodiments are described to present some representative embodiments and illustrate the adaptability of the present invention to different possible implementations.

FIG. 6 illustrates an award determination module 600 and a payout module 602. Each of these modules may be implemented in hardware, firmware, software, or any combination thereof. For example, in one embodiment, the modules 600, 602 are implemented in firmware/software executable by a processing module(s) depicted as the PROC 604, 606 respectively. The award determination module 600 may award a progressive multiplier randomly, such as a mystery award 610. In another embodiment, the date and/or time 612 may be the event that triggers the award. For example, a random date/time may be selected, and when that date/time occurs, one or more of the participating machines is awarded the progressive multiplier. Player participation attributes 614 may influence the decision, such as the number of played paylines, whether the maximum bet was made, which game is being played, etc.

The payout amount may be a triggering event, or one of a plurality of factors considered in triggering the progressive multiplier. For example, a minimum payout may be the event, or one of a plurality of factors considered in determining whether to award the progressive multiplier. As a more particular example, a minimum payout of $500 can be set, and when the player achieves this award in connection with a standard gaming activity (e.g., the game being played by the player), the player may be awarded the progressive multiplier, or may become eligible to win the award if other criteria are met (e.g., matches a random number). Another triggering event/factor may be the player results 618 on the standard gaming activity, such as a particular symbol combination. Another event/factor is player results 620 on a designated gaming activity, such as a particular game, or on sub-symbols 622 of the primary game symbols, etc.

These examples are merely representative, and any type of criteria, factors and/or events may be used to determine when the progressive multiplier will be awarded. Further, any one of these various factors may be exclusively used as a triggering criterion, or alternatively any of these criterion may represent a portion of the triggering criteria. Thus, the illustrated (or other, non-illustrated) criteria may be independently used or collectively used with other criteria to ultimately form the criteria used to determine when the progressive multiplier will be awarded.

When an award determination has been made, a payout module 602 may be used to determine the particular multiplier and/or award to be provided to the player. As previously indicated, representative options include rounding up/down 630 where any residual is added to a reset value. For example, a 10.5 multiplier may be rounded to 10.0, and the remaining 0.5 multiplier may be added to a reset value upon reset by the reset module 624. More particularly, if the reset module 624 resets the multiplier to 2.0, then the resulting multiplier will be 2.0 (reset value)+0.5 (residual)=2.5. In another embodiment, the result may be rounded up/down 632 where the casino keeps any residual, or rounded to a particular fraction/decimal point 634 or to a whole number 636. Alternatively, the exact multiplier value may be used as shown at block 638. Many other options are also available, and those identified in FIG. 6 are merely representative.

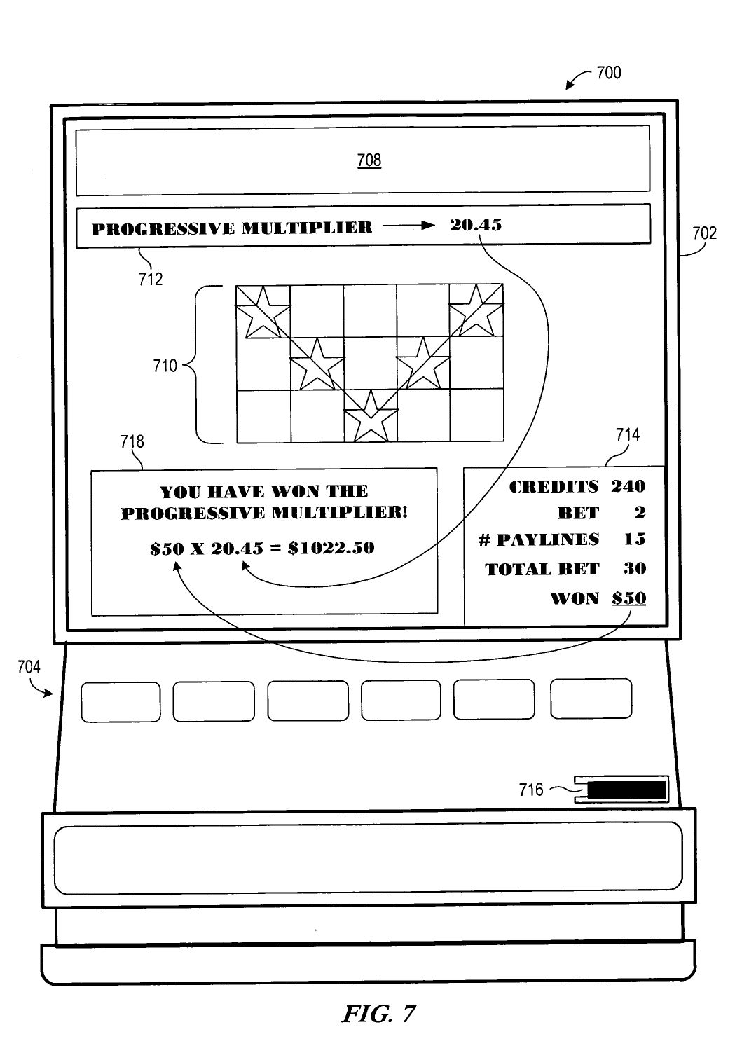

The present invention may be used in connection with slot machines, computing devices and/or other gaming devices. FIG. 7 illustrates a representative embodiment of a casino-style gaming device in which the principles of the present invention may be applied. For purposes of explanation, the description of the gaming device is FIG. 7 is provided in terms of a kiosk or “slot machine” 700. However, the present invention is analogously applicable to other computer-based systems.

The illustrated gaming machine 700 includes a computing system (not shown) to carry out operations according to the invention. The illustrated gaming machine 700 includes a display 702, and a user interface 704, although some or all of the user interface may be provided via the display 702 in touch screen embodiments. The user interface 704 allows the user to control and engage in play of the gaming machine 700. The particular user interface mechanisms associated with user interface 704 is dependent on the type of gaming machine. For example, the user interface 704 may include one or more buttons, switches, joysticks, levers, pull-down handles, trackballs, voice-activated input, or-any other user input system or mechanism that allows the user to play the particular gaming activity. The user interface 704 may allow the user to enter coins, bills, or otherwise obtain credits through vouchers, tokens, credit cards, tickets, etc. Various mechanisms for entering such vouchers, tokens, credit cards, coins, tickets, etc. are known in the art. For example, coin/token input mechanisms, card readers, credit card readers, smart card readers, punch card readers, and other mechanisms may be used to enter wagers. It is through the user interface 704 that the user can initiate and engage in a gaming activity in accordance with the invention. For example, the user can use the user interface 704 to selectively take part in the progressive multiplier feature, and/or may make gaming decisions (e.g., bet max) that will otherwise make the user eligible for such a progressive multiplier feature. While the illustrated embodiment depicts various buttons for the user interface 704, it should be recognized that a wide variety of user interface options are available for use in connection with the present invention, including pressing buttons, touching a segment of a touch-screen, entering text, entering voice commands, or other known user entry methodology. The particular user interface mechanism utilized is not relevant to the present invention.

The display device 702 may include one or more of an electronic display, a mechanical display, and fixed display information such as information such as paytable information associated with a glass/plastic panel 708 on the gaming machine 700. The winning symbol combinations and/or other indicia associated with the play of the game may be presented via mechanical and/or electronic display mechanisms, as depicted in the gaming area 710. In the illustrated embodiment, the progressive multiplier value is shown as depicted at block 712. Alternatively, or additionally, the progressive multiplier may be shown elsewhere, such as a display unit capable of being viewed by one or more users affiliated with the group of users eligible to receive the progressive multiplier.

A display segment or panel 714 may also be provided to display information such as the accumulated credits, current bet amount such as “2” credits (where credits may represent, for example, coins, tokens, dollars, etc.), the number of paylines played, total bet, the number of credits paid out or “won” on a particular play, etc. A wager acceptor 716 is operative to receive wager tokens, coins, bills, credit/debit cards, coupons, smart cards, prepaid casino cards, electronic fund transfer (EFT), tickets, and the like.

In the illustrated embodiment, the user is shown to have received a winning symbol combination of five star symbols in the gaming activity shown via the gaming area 710. If the triggering criteria is met to award the progressive multiplier, the user may be so notified, such as shown in display area 718. In the illustrated embodiment, the user's current winning amount of $50 in the primary gaming activity is multiplied by the progressive multiplier 712 value of 20.45, providing a result of $1,022.50.

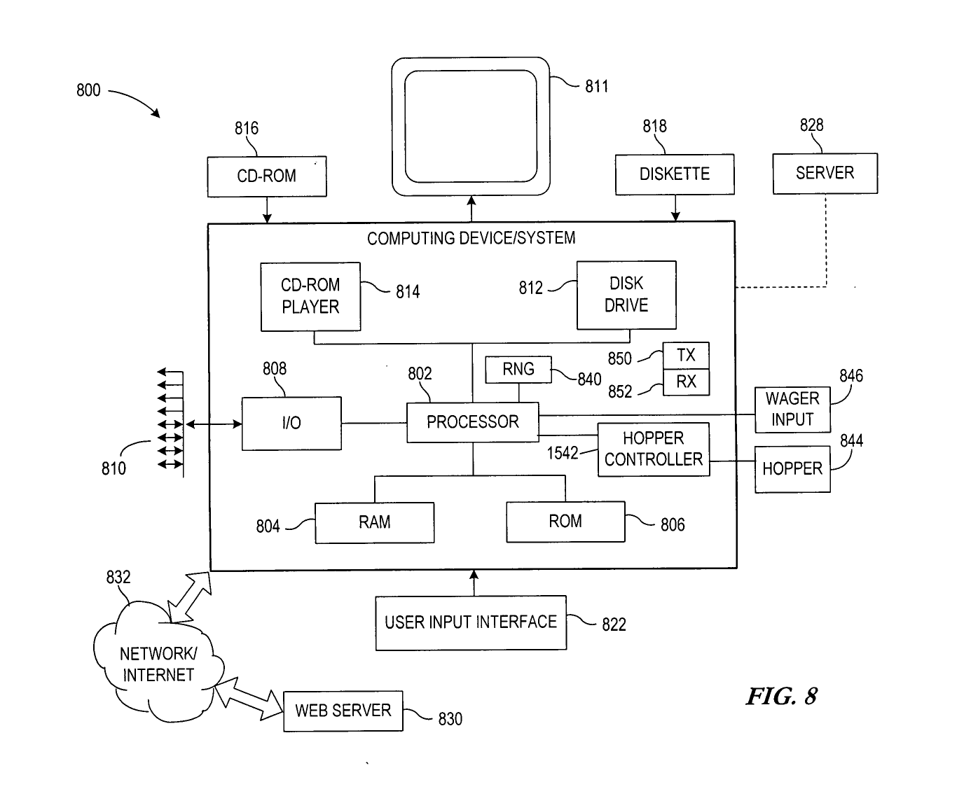

As may now be readily understood, the device 700 may be programmed to play various embodiments of the invention. The present invention may be implemented as a casino gaming machine such as a slot machine or other special purpose gaming kiosk as described in FIG. 7, or may be implemented via computing systems operating under the direction of local gaming software, and/or remotely-provided software such as provided by an application service provider (ASP). The casino gaming machines utilize computing systems to control and manage the gaming activity. An example of a representative computing system capable of carrying out operations in accordance with the invention is illustrated in FIG. 8.

Hardware, firmware, software or a combination thereof may be used to perform the various gaming functions, display presentations and operations described herein. The functional modules used in connection with the invention may reside in a gaming machine as described, or may alternatively reside on a stand-alone or networked computing device/system. The computing structure 800 of FIG. 8 is an exemplary computing structure that can be used in connection with such electronic gaming machines, computers, or other computer-implemented devices to carry out operations of the present invention.

The example computing arrangement 800 suitable for performing the gaming functions in accordance with the present invention typically includes a central processor (CPU) 802 coupled to random access memory (RAM) 804 and some variation of read-only memory (ROM) 806. The ROM 806 may also represent other types of storage media to store programs, such as programmable ROM (PROM), erasable PROM (EPROM), etc. The processor 802 may communicate with other internal and external components through input/output (I/O) circuitry 808 and bussing 810, to provide control signals, communication signals, and the like.

Chance-based gaming systems such as slot machines, in which the present invention is applicable, are governed by random numbers and processors. A display device 811 is used to display the gaming activity as facilitated by one or more random number generators (RNG). RNGs are well-known in the art, and may be implemented using hardware, software operable in connection with the processor 802, or some combination of hardware and software. The present invention is operable using any known RNG, and may be integrally programmed as part of the processor 802 operation, or alternatively may be a separate RNG controller 840.

The computing arrangement 800 may also include one or more data storage devices, including hard and floppy disk drives 812, CD-ROM drives 814, and other hardware capable of reading and/or storing information such as DVD, FLASH drives, etc. In one embodiment, software for carrying out the operations in accordance with the present invention may be stored and distributed on a CD-ROM 816, diskette 818, DVD, FLASH device or other form of media capable of portably storing information. These storage media may be inserted into, and read by, devices such as the CD-ROM drive 814, the disk drive 812, etc. The software may also be transmitted to the computing arrangement 800 via data signals, such as being downloaded electronically via a network, such as the Internet. Further, as previously described, the software for carrying out the functions associated with the present invention may alternatively be stored in internal memory/storage of the computing device 800, such as in the ROM 806.

The computing arrangement 800 is coupled to the display 811, which represents a display on which the gaming activities in accordance with the invention are presented. The display 811 may be any type of known display or presentation screen, such as LCD displays, plasma display, cathode ray tubes (CRT), etc. Where the computing device 800 represents a stand-alone or networked computer, the display 811 may represent a standard computer terminal or display capable of displaying multiple windows, frames, etc. Where the computing device is embedded within an electronic gaming machine (see FIG. 7), the display 811 corresponds to the display screen of the gaming machine/kiosk. A user input interface 822 such as a mouse, keyboard/keypad, microphone, touch pad, trackball, joystick, touch screen, voice-recognition system, etc. may be provided.

The computing arrangement 800 may be connected to other computing devices or gaming machines, such as via a network. The computing arrangement 800 may be connected to a network server 828 in an intranet or local network configuration. The computer may further be part of a larger network configuration as in a global area network (GAN) such as the Internet. In such a case, the computer accesses one or more web servers 830 via the network/Internet 832.

Other components directed to gaming machine implementations include manners of gaming participant payment, and gaming machine payout. For example, a gaming machine including the computing arrangement 800 may also include a hopper controller 842 to determine the amount of payout to be provided to the participant. The hopper controller may be integrally implemented with the processor 802, or alternatively as a separate hopper controller 842. A hopper 844 may also be provided in gaming machine embodiments, where the hopper serves as the mechanism holding the coins/tokens of the machine. The wager input module 846 represents any mechanism for accepting coins, tokens, coupons, bills, electronic fund transfer (EFT), tickets, credit cards, smart cards, membership cards, etc., for which a participant inputs a wager amount.

Additionally, the computing arrangement 800 may include a transmitter (TX) 850, and may include a receiver (RX) 852. These TX 850 and RX 852 components may be discrete components, or aggregated such as in the case of a transceiver. The receiver function provided by the RX 852 can be configured to receive information from any type of network, such as a local area network (LAN), wireless LAN (e.g., 802.11 a/b/g), wired network (e.g., Internet), wireless network (e.g., Global System for Mobile Communications/General Packet Radio Service (GSM/GPRS), proximity networks (e.g., Bluetooth, peer-to-peer networks), and/or other wired/wireless network technologies. For example, the RX 852 may receive progressive multiplication-based value information via the web server 830, server 828, etc. Information such as wager information or other data used by a server to establish or adjust the progressive multiplication-based value can be provided to the appropriate server 828, 830 or other device or network entity via the TX 850.

It should also be recognized that the computing arrangement 800 of FIG. 8 may be implemented in a gaming apparatus, or in a server or other network entity that determines and provides a progressive multiplication-based value in accordance with the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., slot machines involving poker or card games that could be played via table games).

What is claimed is:

1. A method for enhancing payout awards, comprising:
increasing a multiplication-based value;
awarding the multiplication-based value to at least one of a plurality of gaming systems; and
applying the awarded multiplication-based value to an amount otherwise awarded to the at least one gaming system in connection with participation in a gaming activity.

2. The method of claim 1, wherein increasing a multiplication-based value comprises progressively increasing the multiplication-based value.

3. The method of claim 1, wherein awarding the multiplication-based value comprises awarding the multiplication-based value to a plurality of the gaming systems.

4. The method of claim 1, wherein awarding the multiplication-based value comprises allocating the multiplication-based value among a plurality of the gaming systems subject to the award.

5. The method of claim 1, wherein increasing a multiplication-based value comprises increasing the multiplication-based value on average.

6. The method of claim 1 further comprising allowing the multiplication-based value to increase or decrease from one multiplication-based value to another multiplication-based value, while the multiplication-based value trends upwards over time.

7. The method of claim 1, wherein increasing a multiplication-based value comprises increasing the multiplication-based value based on increase criteria.

8. The method of claim 7, wherein increasing the multiplication-based value based on increase criteria comprises increasing the multiplication-based value as total wager amounts of the plurality of gaming systems increase.

9. The method of claim 1, wherein awarding the multiplication-based value to at least one of a plurality of gaming systems comprises determining to which of the plurality of gaming systems the multiplication-based value is to be awarded.

10. The method of claim 9, wherein determining to which of the plurality of gaming systems the multiplication-based value is to be awarded comprises randomly selecting one of the plurality of gaming systems to award the multiplication-based value.

11. The method of claim 9, wherein determining to which of the plurality of gaming systems the multiplication-based value is to be awarded comprises identifying which of the plurality of gaming systems produces a predetermined result in connection with participation in a gaming activity.

12. The method of claim 9, wherein determining to which of the plurality of gaming systems the multiplication-based value is to be awarded comprises considering player participation attributes to influence the determination of which of the plurality of gaming systems the multiplication-based value is to be awarded.

13. The method of claim 9, further comprising determining when the multiplication-based value is to be awarded.

14. The method of claim 13, wherein determining when the multiplication-based value is to be awarded comprises identifying a designated time, date, or date and time in which the multiplication-based value is to be awarded.

15. A method for enhancing payout awards, comprising:
progressively increasing a multiplication-based value until it is awarded;
determining when the multiplication-based value is to be awarded to a particular gaming system in a participating group of gaming systems; and
applying the awarded multiplication-based value to an amount otherwise awarded to the particular gaming system in connection with its participation in a gaming activity.

16. The method of claim 15, further comprising resetting the multiplication-based value after it has been awarded.

17. The method of claim 15, wherein determining when the multiplication-based value is to be awarded comprises awarding the multiplication-based value in response to gaming activity participation on the particular gaming system.

18. The method of claim 15, wherein determining when the multiplication-based value is to be awarded comprises randomly selecting the particular gaming system to be awarded the multiplication-based value.

19. The method of claim 18, wherein randomly selecting the particular gaming system comprises comparing a value randomly generated at each of the gaming systems of the group to a set value.

20. The method of claim 18, wherein randomly selecting the particular gaming system comprises comparing a first value randomly generated at a server to second values randomly generated at each of the gaming systems of the group.

21. The method of claim 18, wherein randomly selecting the particular gaming system comprises comparing a first value randomly generated at a server to respective set values at each of the gaming systems of the group.

22. The method of claim 15, wherein determining when the multiplication-based value is to be awarded comprises determining which of the gaming systems of the participating group are eligible to be awarded the multiplication-based value, and monitoring award criteria for the eligible gaming systems.

23. The method of claim 22, wherein the eligible gaming systems comprise the gaming systems operated by an eligible user.

24. The method of claim 22, wherein the eligible gaming systems comprise the gaming systems in which a wager is placed to purchase eligibility.

25. The method of claim 24, wherein the wager placed to purchase eligibility is unrelated to a wager of a primary gaming activity of the gaming system.

26. The method of claim 22, wherein the eligible gaming systems comprise the gaming systems in which a threshold wager has been placed.

27. The method of claim 22, wherein the eligible gaming systems comprise the gaming systems in which a threshold number of paylines has been selected for participation.

28. The method of claim 15, wherein progressively increasing a multiplication-based value comprises progressively increasing a multiplier.

29. The method of claim 15, wherein progressively increasing a multiplication-based value comprises progressively increasing a factorial.

30. The method of claim 15, wherein progressively increasing a multiplication-based value comprises progressively increasing an exponent.

31. The method of claim 15, wherein progressively increasing a multiplication-based value comprises progressively increasing the multiplication-based value based on at least play of the gaming systems eligible for being awarded the multiplication-based value.

32. The method of claim 31, wherein progressively increasing the multiplication-based value based on at least play of the eligible gaming systems comprises increasing the multiplication-based value as a result of wagers placed via at least the eligible gaming systems.

33. The method of claim 32, further comprising increasing the multiplication-based value as a result of wagers placed via one or more gaming system that are not eligible for being awarded the multiplication-based value.

34. The method of claim 32, wherein increasing the multiplication-based value as a result of wagers placed via at least the eligible gaming systems comprises increasing the multiplication-based value substantially proportionally to a value of the wagers placed via the eligible gaming systems.

35. The method of claim 15, further comprising a plurality of the multiplication-based values, and wherein progressively increasing the multiplication-based value comprises progressively increasing the plurality of the multiplication-based values.

36. The method of claim 15, further comprising applying one or more multiplier value limitation rules to reduce a rate of increase of the multiplier value upon reaching a threshold multiplier value.

37. The method of claim 15, further comprising applying one or more multiplier value limitation rules to discontinue further increases of the multiplier value upon reaching a threshold multiplier value.

38. A method comprising:
progressively increasing a multiplication-based value available to a gaming system, wherein the multiplication-based value subsists across multiple gaming system participants;
awarding the multiplication-based value to one of the gaming system participants; and
applying the awarded multiplication-based value to an awarded payout associated with the gaming activity being played on the gaming system.

39. The method of claim 38, wherein awarding the multiplication-based value to one of the gaming system participants comprises awarding the multiplication-based value to a current gaming system participant in response to gaming activity transpiring on the gaming system.

40. The method of claim 39, wherein awarding the multiplication-based value to the current gaming system participant comprises randomly awarding the multiplication-based value to the current gaming system participant during any gaming activity participation on the gaming system.

41. The method of claim 39, wherein awarding the multiplication-based value to the current gaming system participant comprises awarding the multiplication-based value to the current gaming system participant based on a result obtained through participation in a the gaming activity.

42. The method of claim 38, wherein the multiplication-based value comprises a multiplier value.

43. The method of claim 38, wherein the multiplication-based value comprises an exponential value.

44. The method of claim 38, wherein the multiplication-based value comprises a factorial value.

45. The method of claim 38, wherein progressively increasing a multiplication-based value available to a gaming system comprises increasing the multiplication-based value for a current user of the gaming system.

46. The method of claim 38, wherein progressively increasing a multiplication-based value available to a gaming system comprises increasing the multiplication-based value to a qualified user whose qualified status enables the first gaming system to activate a progressively increasing multiplication-based value feature.

47. The method of claim 46, wherein increasing the multiplication-based value to a qualified user comprises increasing the multiplication-based value to a user who has purchased a progressive multiplication-based value function.

48. The method of claim 46, wherein increasing the multiplication-based value to a qualified user comprises increasing the multiplication-based value to a user who has registered for a progressive multiplication-based value function.

49. The method of claim 46, wherein progressively increasing the multiplication-based value comprises increasing the multiplication-based value based at least in part on wagers placed by a plurality of users of the gaming system.

50. A gaming apparatus comprising:
a receiver configured to receive a progressively increased multiplication-based value associated with an enhanced payout;
a processor configured to determine a standard payout awarded in connection with a gaming activity played via the gaming apparatus, and to calculate the enhanced payout by calculating a mathematical result of applying the multiplication-based value to the standard payout.

51. The gaming apparatus as in claim 50, wherein the gaming apparatus comprises a slot machine.

52. The gaming apparatus as in claim 50, wherein the gaming apparatus comprises a computing device.

53. The gaming apparatus as in claim 50, wherein the gaming apparatus comprises a mobile device.

54. A server comprising:
a receiver configured to receive information influencing a multiplication-based value;
a processor configured to repeatedly calculate the multiplication-based value using the information as at least some of the calculation input, wherein the information is at least partially responsible for the multiplication-based value increasing at least some of the time;
a transmitter configured to provide a current state of the multiplication-based value at least at a time when the multiplication-based value has been awarded to a gaming participant.

55. The server as in claim 54, wherein the transmitter is configured to transmit the current state of the multiplication-based value continuously.

56. The server as in claim 54, wherein the information is at least partially responsible for the multiplication-based value progressively increasing over time.

57. The server as in claim 54, wherein the information includes wager information.

58. The server as in claim 54, wherein the multiplication-based value comprises a multiplier value capable of being multiplied by a first award received by a gaming participant to create a second award.

59. A gaming system comprising:
a plurality of gaming devices;
a server comprising a processor configured to repeatedly calculate a multiplication-based value using information from the plurality of gaming devices as at least some of the calculation input, wherein the information is at least partially responsible for increasing the multiplication-based value;
wherein each of the plurality of gaming devices comprises:
a receiver configured to receive the multiplication-based value from the server; and
a processor configured to determine a standard payout awarded in connection with a gaming activity, and to calculate an enhanced payout by calculating a mathematical result of applying the multiplication-based value to the standard payout.

60. The gaming system of claim 59, wherein the server further comprises a receiver configured to receive the information from each of the plurality of gaming devices via a network, and a transmitter to provide the multiplication-based value via the network.

61. The gaming system of claim 59, wherein each of the plurality of gaming devices further comprises a transmitter configured to transmit the information to the server via a network.

62. A computer-readable medium having instructions stored thereon which are executable by a computer system for providing enhanced payout awards by performing steps comprising:
progressively increasing a multiplication-based value until it is awarded;
determining when the multiplication-based value is to be awarded to a particular gaming system in a participating group of gaming systems; and
applying the awarded multiplication-based value to an amount otherwise awarded to the particular gaming system in connection with its participation in a gaming activity.

63. A system for enhancing payout awards, comprising:
means for increasing a multiplication-based value;
means for awarding the multiplication-based value to at least one of a plurality of gaming systems; and
means for applying the awarded multiplication-based value to an amount otherwise awarded to the at least one gaming system in connection with participation in a gaming activity.
